(19) United States
(12) Patent Application Publication
(10) Pub. No.: US 2003/0190407 A1
(43) Pub. Date: Oct. 9, 2003

(54) Method for forgery-proof marking;forgery-proof marking and kit

(76) Inventors: Georg Bauer, (US); Andr?eacute; Josten, Hemhofen (DE); Harald Walter, Erlangen (DE)

Correspondence Address: Mark S Ellinger, Fish & Richardson, Suite 3300, 60 South Sixth Street, Minneapolis, MN, 55402, US

(21) Appl. No.: 10/240,896

(22) PCT Filed: Feb. 1, 2002
(86) PCT No.: PCT/EP02/01058

(30) Foreign Application Priority Data
Feb. 5, 2001 (DE) 101 05 339.8

(51) Int. Cl. B44F 1/12

(52) U.S. Cl. 427/7; 428/195.1

(57) ABSTRACT

The invention relates to a counterfeit-proof marking having a carrier layer (1, 1a, 1b) having a communicating pore space and a probe formed from a first biomolecule contained therein. In order to make possible a rapid and reliable identification of the marking on the spot, it is provided according to the invention that the carrier layer (1, 1a, 1b) has a first marking surface (6) containing the probe and a second reference surface (7) not containing the probe.

The invention relates to a process for counterfeit-proof marking, a counterfeit-proof marking according to the precharacterizing clause of claim 19 and a kit having a counterfeit-proof marking.

The invention relates in particular to the safety, coding and identification field.

It is known from DE 197 38 816 A1 to use nucleic acids bound to a solid for marking. For detection, the nucleic acids, however, must be removed from the solid by an extraction process. The nucleic acids present in solution must then be amplified by means of a specific reaction, such as the PCR. In subsequent steps, the amplified nucleic acid sequence is analyzed. The process is time-consuming and labor-intensive and is not suitable for detection of the authenticity on the spot. Moreover, extraction of the nucleic acids applied for marking is not possible or desirable in the case of every solid.

A further process for the identification of a marking provided on a solid is known from DE 198 11 730 A1. The marking has, as a probe, a nucleotide sequence bound to a solid phase. The nucleotide sequence is brought into contact with a corresponding nucleotide sequence which is bound to a further solid phase of a detecting agent. This process is only suitable for plane surfaces which make possible close contact between marking and detection side. The binding of the probe and the detecting agent to solid phases is laborious. The marking and detection molecules bound to the solid phases are unstable to mechanical stress and susceptible to soiling, which involves a low stability of the marking.

It is known from the model-forming U.S. Pat. No. 5,139,812 to use a specified nucleic acid-containing ink for the counterfeit-proof marking of articles. The marking is applied to a secret position of a valuable article. In order to be able to mark a plurality of articles distinguishably, different markings are applied using the ink. The identification of a marking applied in such a way is carried out by binding a further nucleic acid to the specified nucleic acid, and by identification of the binding. For this, the marking must be removed from the article and detected by means of a multistage process, e.g. by means of antibodies or by the identification of a radioactive marking. The identification of the marking is complicated. It cannot be carried out on site. A similar process is known from WO 87/06383.

EP 0 745 690 A2 describes “molecular beacons” and their use for hybridization. Use for the detection of markings is not disclosed in this document.

U.S. Pat. No. 5,866,336 describes primers marked with a fluorophore. The primers are amplified by means of the polymerase chain reaction. In the hybridized state, refolding of the primers is induced. The fluorescence behavior of the fluorophore provided on the primer thus changes. The known process is unsuitable for rapid identification of a marking, because it necessitates the cost-intensive and time-consuming polymerase chain reaction.

DE 199 01 761 discloses a process for detection of the hybridization of DNA by means of alteration of a redox potential. Such an alteration of the redox potential cannot be detected without problems. The known process likewise does not allow rapid and simple identification of a marking.

It is an object of the present invention to eliminate the disadvantages according to the prior art. In particular, a process and a counterfeit-proof marking are to be specified which allows [sic] simple and rapid identification of the marking on the spot.

This object is achieved by the features of claims 1, 19 and 33. Claims 2 to 18, 20 to 32 and 34 to 37 specify further advantageous features.

According to the invention, a process for the identification of a counterfeit-proof marking provided on an article is provided, which marking has a carrier layer having a communicating pore space with a probe contained therein formed of first biomolecules, the carrier layer having a first marking surface containing the probe and a second reference surface not containing the probe, having the following steps:

aa) impregnation of the carrier layer with an identifying agent which contains at least sectionally second biomolecules formed complementarily to the first biomolecules and

bb) identification of a reaction occurring in the carrier layer between the first and the second biomolecules, the marking surface being observed and a fluorescence signal emanating therefrom being analyzed, and a check being carried out by observation of the reference surface.

The proposed process allows a counterfeit-proof marking and a rapid and simple identification of the marking.

By the carrier layer having a marking surface containing the first probe and a reference surface not containing the second probe, a check of the measured fluorescence signal is possible. The observation of the reference surface makes possible a conclusion about the background of the measurement. An identification of the marking can thus be carried out with high reliability. The term “reference surface” is to be understood generally. If the carrier layer is a constituent of the article to be marked itself, the reference surface can also be the surface of the marked article. The reference surface can also be identical to the marking surface if the reference surface is observed using the identifying agent before the impregnation of the carrier layer and a measurement of the background is carried out. After this, the carrier layer can be impregnated with the identifying agent and then the fluorescence signal emanating therefrom can be measured and analyzed.

For identification, the marking surface and the reference surface are observed and in particular the difference between the fluorescence signals emanating therefrom is analyzed. The analysis can be carried out automatically using a suitable manual apparatus.

The observation of a fluorescence signal emanating from the marking surface makes possible a detection of a specific reaction occurring between the first and the second biomolecule in one stage, in particular leaving out a washing step or the addition of further chemical reagents. In particular, it is not necessary to remove the first biomolecules used for the marking from the carrier layer, then to amplify and subsequently to carry out a detection by addition of second biomolecules. It is further not necessary to carry out a washing step or the like after the application of the identifying agent. It is also not necessary for the identification of the marking to remove the carrier layer from the marked article.—The proposed marking can be produced simply and inexpensively. It is outstandingly suitable for marking branded products which are being counterfeited to an increasing extent, e.g. cigarettes, clothing, automotive replacement parts and the like. Using the proposed marking, it is possible for the manufacturer of the branded products to spot check, for example, the goods in stock at wholesalers for their authenticity.

According to an advantageous embodiment, the carrier layer in step lit. bb) is irradiated with light of a specified wavelength, and a fluorescence reaction indicating the specific binding of the first biomolecule to the second biomolecule is observed. Such a detection reaction can be carried out simply on the spot by means of a suitable manual apparatus.

The carrier layer can be prepared from a light-transparent or a reflecting material. It can be, for example, a nonwoven glass fiber material. The glass fibers can be mirrored. Using this measure, the light yield deflected from the carrier layer can be considerably increased.

The carrier layer is expediently prepared from one of the following materials: cellulose, nitrocellulose, nylon, polyacrylamide gel, porous SiO₂, nonwoven glass fiber material.

The marking surface can be provided with a mixture of different biomolecules containing the probe. This increases the counterfeit safety of the marking. It is not known to potential counterfeiters which of the biomolecules contained in the carrier layer is used as a marker. Moreover, it is hardly possible to analyze or identify the biomolecules.

The probe is expediently formed from one of the following biopolymers: synthetic single-stranded nucleic acids or their natural and/or synthetic analogs, antigens, proteins, such as antibodies, antibody fragments, derivatives of antibodies or antibody fragments, nucleic acid-binding proteins, receptors, ligands. Of course, similarly acting biomolecules can also be utilized for the production of the probe.

According to a further embodiment, the probe can be applied to the carrier layer in a specified geometric arrangement. It can be applied to the carrier layer by means of a printing process, e.g. by means of an inkjet printing head or by means of screen printing. The geometric arrangement can be a specified pattern, e.g. a barcode.

It is further advantageous that the carrier layer has a first application surface, which is connected to the marking surface or to a plurality of marking surfaces via a first route or first routes. The first application surface can also be connected to the reference surface or to a plurality of reference surfaces via a second route or second routes. A second and/or further application surfaces can also be provided, which are connected to one or more marking surfaces and/or reference surfaces. In the abovementioned cases, the identifying agent is transported along the first and/or second route by means from capillary forces from the application surface(s) to the marking surface and/or reference surface. The carrier layer is expediently covered at least sectionally with a protective layer which can be designed to be transparent. Using the abovementioned features, it is possible to design the application surface, for example, as an opening in the protective layer. The arranged marking and/or reference surface(s) removed from the application surface can in this case be covered by the protective layer and protected from contamination. This further increases the reliability of the proposed process. The transparent design of the protective layer makes possible an optical fluorescence identification of the marking.

According to a further advantageous embodiment feature, the carrier layer is fixed to the article to be marked by means of an adhesive or by lamination. The carrier layer can be provided on its fixing-sided surface with an adhesive film, preferably an adhesive film having a peelable protective film. The carrier layer can thus be designed in the style of a self-adhesive label.

According to a further embodiment, a dye can be added to the identifying agent indicating its spread in the carrier layer. This is in particular advantageous if the marking and/or reference surface(s) are arranged far away from the application surface. In this case, it can be checked by means of the dye whether the identifying agent has actually been transported as far as the marking and/or reference surface by means of capillary forces. The control of the spread of the identifying agent can also be carried out by means of a conductivity measurement.

The identifying agent can be added to the application surface formed on the carrier layer by means of a capillary. A suitable specified amount of the identifying agent can also be contained in the capillary [lacuna] a simple manner. The identifying agent, however, can also be contained in a pen or a pipette.

According to a further stipulation of the invention, it is provided in the case of a counterfeit-proof marking that the carrier layer has on [sic] a first marking surface containing the probe and a second reference surface not containing the probe.—Such a marking can be identified simply, rapidly and with high reliability on the spot by means of optical fluorescence methods. It is not necessary to remove such a marking and to treat it by means of complicated wet-chemical methods for the identification of the marked article. Because of the advantageous embodiments of the marking, reference is made to the preceding embodiments, which correspondingly also apply to the claimed counterfeit-proof marking.

According to a further stipulation of the invention, a kit having a counterfeit-proof marking according to the invention and an identifying agent containing a second biomolecule corresponding to the probe is provided.

According to a particularly advantageous embodiment of the kit, the identifying agent can be contained in a capillary. The capillary can be contained in a pen-like holder, e.g. like a refill.

Exemplary embodiments of the invention are illustrated in greater detail below with the aid of the drawings in which:

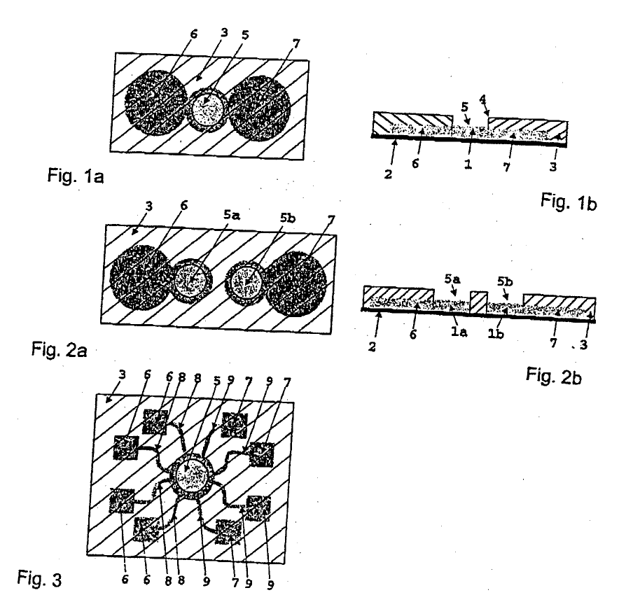

FIG. 1a shows a top view onto a second counterfeit-proof marking,

FIG. 1b shows a cross-sectional view according to FIG. 1a,

FIG. 2a shows a top view onto a second counterfeit-proof marking,

FIG. 2b shows a cross-sectional view according to FIG. 2a,

FIG. 3 shows a top view onto a third counterfeit-proof marking,

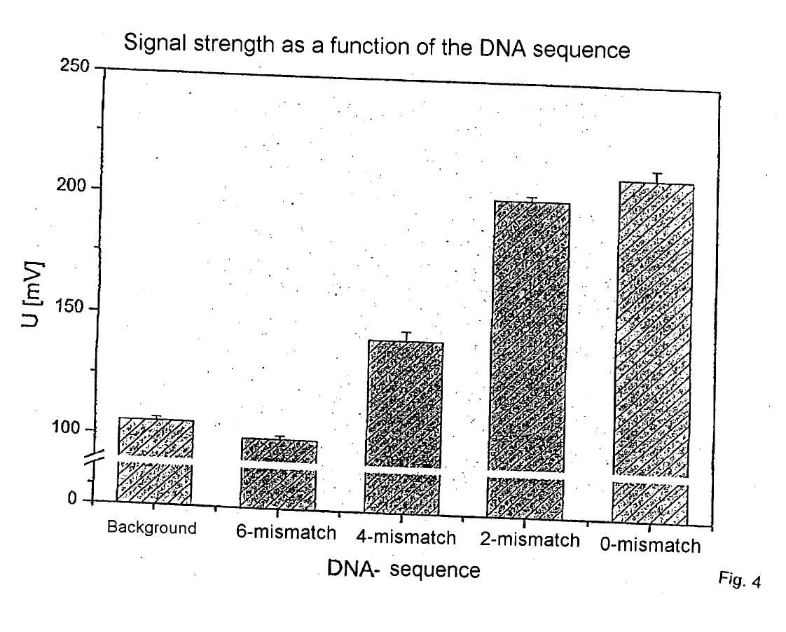

FIG. 4 shows the signal strength as a function of different DNA sequences,

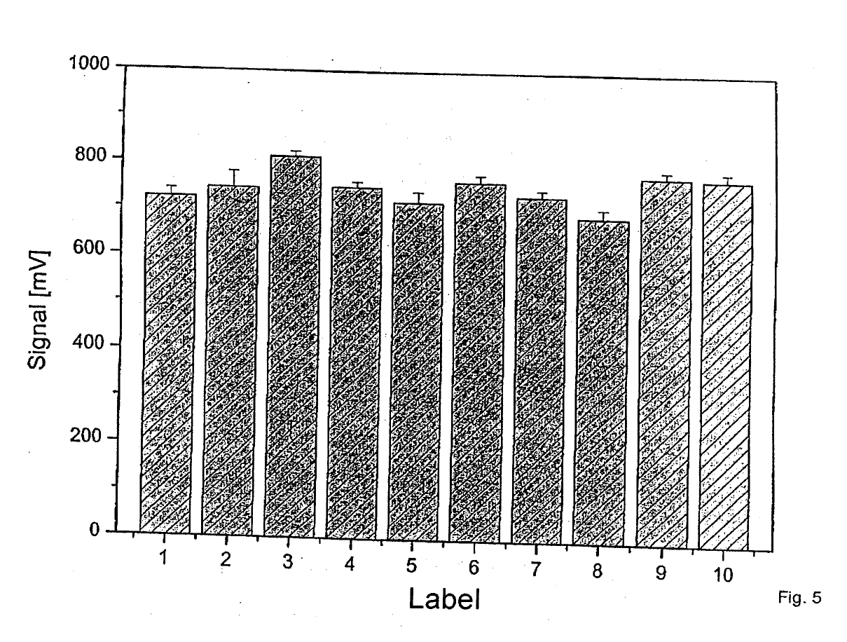

FIG. 5 shows the reproducibility of the fluorescence signal,

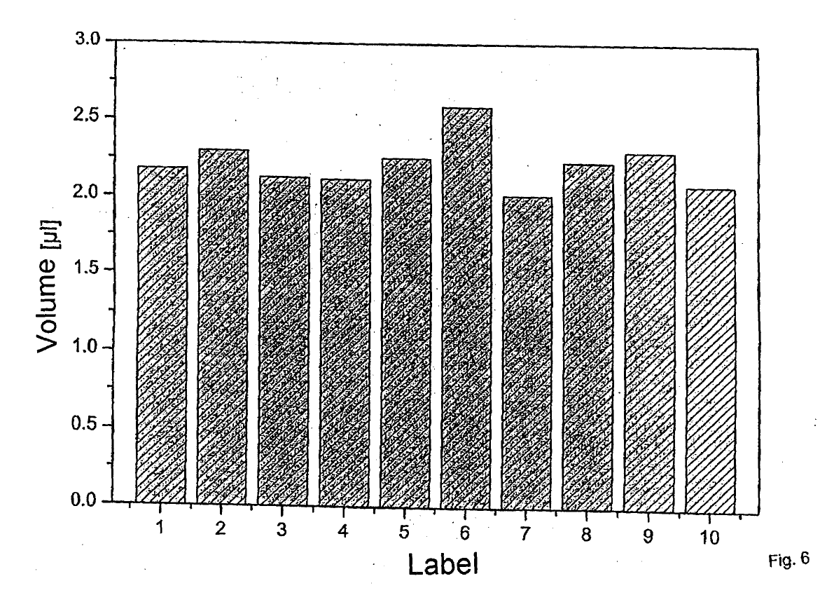

FIG. 6 shows the reproducibility of the amount of identifying agent incorporated into the carrier

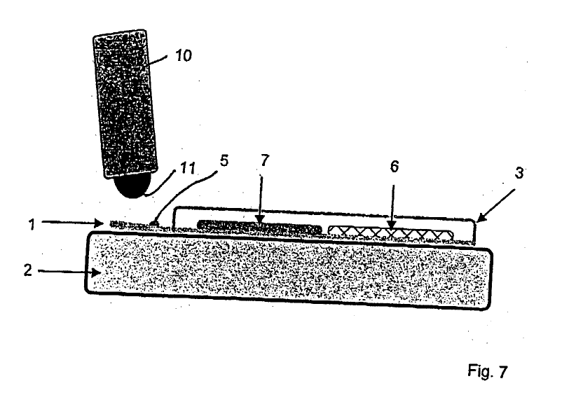

FIG. 7 shows a schematic cross-sectional view of a counterfeit-proof marking and of an identifying agent and

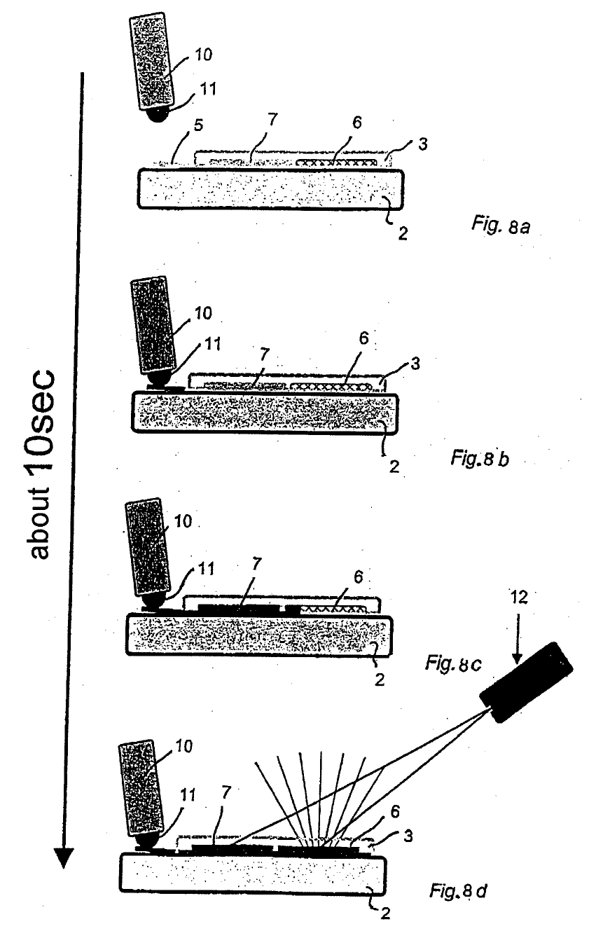

FIG. 8a-d shows the process course in schematic cross-sectional views.

In the [sic] in FIGS. 1a to 3, various embodiments of counterfeit-proof markings are shown. The counterfeit-proof markings are in each case effected here in the style of a label.

In the first counterfeit-proof marking shown in FIG. 1a and b, a carrier layer which has a communicating pore space is designated by the reference symbol 1. The carrier layer can consist, for example, of a filter paper, a nonwoven glass fiber material or the like. Contained in the carrier layer is a first biomolecule, e.g. 3 pmol of an oligonucleotide having a length of 30 bp. The biomolecule can be bonded, e.g. covalently, to the carrier layer. The carrier layer 1 is applied to a carrier 2. This can be a plastic film or metal foil or a glass slide, whose side facing away from the carrier layer 1 is coated with a pressure-sensitive adhesive. However, it is also possible to fix the carrier layer 1 to the carrier 2 by means of a double-sided adhesive tape. The covering layer can consist, for example, of a siliconized plastic layer or a siliconized paper. A protective layer 3 peripherally covers the carrier layer 1. It serves for the fixing of the carrier layer 1 and for its protection. An opening 4 provided in the protective layer 3 delineates an application surface 5. The application surface 5 serves for the acceptance of a liquid identifying agent. The liquid identifying agent applied to the application surface 5 is absorbed into the interior of the carrier layer 1 by means of capillary forces.

In the first counterfeit-proof marking shown in FIG. 1a and b, the carrier layer 1 is designed in the form of three circular areas connected to one another. A first circular area forms a marking surface 6, a second circular area connected therewith forms the application surface 5 and a third circular area connected to the application surface 5 forms a reference surface 7. The carrier layer 1 thus formed is in turn applied to a carrier 2. It is covered with a protective layer 4, e.g. prepared from a transparent plastic film. In the region of the second circular surface, the protective layer 4 has a circular opening 4 which forms the application surface 5. In the present example, only the marking surface 6 contains the first biomolecule. The application surface 5 and the reference surface 7 do not contain the first biomolecule. In the present exemplary embodiment, the marking surface 6 and the reference surface 7 are fully covered by the protective layer 3. Biomolecules contained therein for identification or for reference are particularly well protected.—By applying a liquid identifying agent to the application surface 5, this is absorbed both in the marking surface 6 and in the reference surface 7 by means of capillary forces. The reaction of the first biomolecule with a second biomolecule corresponding thereto contained in the identifying agent, which can be designed, for example, as a molecular beacon optionally occurs there. Fluorescent light occurring in the reaction is deflected by the transparent protective layer 3 and can be observed as an identification signal.

In the second counterfeit-proof marking shown in FIG. 2a and b, a first application surface 5a is connected to the marking surface 6. A second application surface 5b is connected to the reference surface 7. The first application surface 5a and the marking surface 6 are part of a first carrier layer 1a, the second application layer 5b and the reference surface 7 connected thereto are part of a second carrier layer 1b. The first carrier layer 1a and second carrier layer 1b are separate from one another. In this embodiment, it is possible to supply the first application surface 5a and second application surface 5b with different identification substances.

FIG. 3 shows a top view of a third counterfeit-proof marking. The application surface 5 is connected here via first routes 8 to a plurality of marking surfaces. It is further connected via second routes 9 to a plurality of reference surfaces 7. A liquid identifying agent applied to the application surface 5 is transported by means of capillary forces via the first routes 8 and the second routes 9 to the marking surface 6 and reference surface 7. The marking surface 7 and reference surface 8 are in each case fully covered by the protective layer 3.

In comparison, FIG. 4 shows the strength of a fluorescence signal which is indicated in mV on the Y axis. The results of the background, a hybridization with a molecular beacon, are shown, either 6, 4, 2 or 0 base mispairings occurring along the hybridized section. Even a mispairing of 2 bases is distinguishable using the present invention. A mispairing of 4 bases leads to a drastically lower signal. This confirms the high specificity of the process according to the invention.

In FIG. 5, the signal intensity on the Y axis in mV is shown. The reproducibility of a signal on repeated use of an identifying agent with one and the same molecular beacon has been tested here. It is seen that the signal occurring has a variation of 4.7% compared with a mean value.

In FIG. 6, the reproducibility of the filling of a specified carrier layer is shown. Applied to the Y axis is the volume of identifying agent in each case contained in the carrier layer. The degree of filling has been determined gravimetrically. It shows a mean deviation of 7.2% compared to a mean value.

FIG. 7 shows a schematic cross-sectional view of an exemplary embodiment of the process. In this case, a liquid identifying agent is taken up in a capillary 10 in an amount of 1 μl. The capillary 10 can be held, for example, in the style of a refill in a pen. The identifying agent expediently contains a molecular beacon in a Dig Easyhyb buffer (Roche, Biomedicals) in a concentration of 1 pmol/μl. A yellow dye, e.g. the food dye E 104, can be added to the solution. The identifying agent 11 can be added dropwise from the capillary 10 to an application surface 5 of the carrier layer 1. In the region of the application surface 5, the carrier layer 1 is not covered by the protective layer 3. The marking surface 6 is formed here as a first layer having a communicating pore space, which lays on the carrier layer 1. The reference surface 7 is formed here from a second layer having a communicating pore space, which likewise lays on the carrier layer. The first and/or second layer can be prepared, for example, from a nylon membrane (Amersham Hybond N+), 3 pmol of a 30 bp oligonucleotide being contained therein as a first biomolecule. Both the marking surface 6 and the reference surface 7 are covered by the protective layer 3, which is designed as a transparent plastic film.

Identifying agent applied to the application surface 5 is transported to the marking surface 6 and to the reference surface 7 by means of capillary forces. A possibly occurring signal is deflected via the transparent protective layer 3.

In FIG. 8a to d, the process according to the invention is again shown schematically in individual steps.

The identifying agent absorbed into the marking surface 6 and reference surface 7 by means of capillary forces is irradiated using an excitation light source 12. The first biomolecules contained in the marking surface 6 hybridize with second biomolecules contained in the identification substance 11, which are designed at least sectionally corresponding to the first biomolecules. The second biomolecules are expediently designed as a molecular beacon. The molecular beacon can be provided with an NIR fluorophore and a quencher suitable for this at the 3′ or 5′ end. Expediently, Cy 5 (Amersham) is used as the fluorophore and BHQ 3 (Biosearch Technologies Inc.) as the quencher. In the hybridization, an alteration of the secondary structure of the molecular beacon occurs. A fluorophore marking provided on the molecular beacon can be excited by means of an excitation light source 12, e.g. a laser diode, after hybridization has taken place. The excitation light can be filtered using a conventional polymeric Roscolene 862—True Blue—filter (Rosco). The fluorescent light irradiated from the fluorophore is deflected from the protective layer 3 and can be observed by means of a photodiode. The occurrence of the fluorescence signal indicates the authenticity of the marking.

As can be seen from FIG. 8a to d, the authenticity of the marking can be checked rapidly and simply on the spot. The test procedure takes up only approximately 10 seconds. No washing process or removal of the marking from the marked article is necessary. The proposed process and the counterfeit-proof marking is [sic] outstandingly suitable for the marking of mass-produced products. Their identification can be carried out using an inexpensively manufacturable manual apparatus.

List of Reference Symbols

1 carrier layer

2 carrier

3 protective layer

4 opening

5 application surface

6 marking surface

7 reference surface

8 first route

9 second route

10 capillary

11 identification substance

12 excitation light source

1. Process for the identification of a counterfeit-proof marking provided on an article, which marking has a carrier layer (1, 1a, 1b) having a communicating pore space with a probe contained therein formed of first biomolecules,
the carrier layer (1, 1a, 1b) having a first marking surface (6) containing the probe and a second reference surface (7) not containing the probe,
having the following steps:
aa) impregnation of the carrier layer (1, 1a, 1b) with an identifying agent (11) which contains second biomolecules which are at least sectionally formed complementarily to the first biomolecules and
bb) identification of a reaction occurring in the carrier layer (1, 1a, 1b) between the first and the second biomolecules,
the marking surface (6) being observed and a fluorescence signal emanating therefrom being analyzed, and a check being carried out by observation of the reference surface.

2. Process according to claim 1, the carrier layer (1, 1a, 1b) in step lit. bb being irradiated with light of a specified wavelength, and a fluorescence reaction indicating the specific binding of the first biomolecule to the second biomolecule being observed.

3. Process according to one of the preceding claims, the carrier layer (1, 1a, 1b) being prepared from a light-transparent or a reflecting material.

4. Process according to one of the preceding claims, the carrier layer (1, 1a, 1b) being prepared from one of the following materials: cellulose, nitrocellulose, nylon, polyacrylamide gel, porous SiO₂, nonwoven glass fiber material.

5. Process according to one of the preceding claims, the marking surface being provided with a mixture of different biomolecules containing the probe.

6. Process according to one of the preceding claims, the probe being formed from one of the following biopolymers:
synthetic single-stranded nucleic acids or their natural and/or synthetic analogs, antigens, proteins, such as antibodies, antibody fragments, derivatives of antibodies or antibody fragments, nucleic acid-binding proteins, receptors, ligands.

7. Process according to one of the preceding claims, the probe being applied to the carrier layer (1, 1a, 1b) in a specified geometric arrangement.

8. Process according to one of the preceding claims, the probe being applied to the carrier layer (1, 1a, 1b) by means of a printing process, preferably by means of an inkjet printing head.

9. Process according to one of the preceding claims, the carrier layer (1, 1a, 1b) having a first application surface (5a), which is connected to the marking surface (6) or to a plurality of marking surfaces via a first route (8) or first routes.

10. Process according to one of the preceding claims, the first application surface (5a) being connected to the reference surface (7) or to a plurality of reference surfaces via a second route (9) or second routes.

11. Process according to one of the preceding claims, a second and/or further application surfaces (5, 5a, 5b) being provided, which are connected to one or more marking surfaces (6) and/or reference surfaces (7).

12. Process according to one of the preceding claims, the identifying agent (11) being transported along a first and/or second route by means of capillary forces from the application surface (5, 5a, 5b) to the marking surface (6) and/or reference surface (7).

13. Process according to one of the preceding claims, the carrier layer (1, 1a, 1b) being covered at least sectionally with a protective layer (3).

14. Process according to one of the preceding claims, the protective layer (3) being designed to be transparent.

15. Process according to one of the preceding claims, the carrier layer (1, 1a, 1b) being fixed to the article to be marked by means of an adhesive or by lamination.

16. Process according to one of the preceding claims, the carrier layer (1, 1a, 1b) being provided on its fixing-sided surface with an adhesive film, preferably an adhesive film having a peelable protective film.

17. Process according to one of the preceding claims, a dye being added to the identifying agent (11) indicating its spread in the carrier layer (1, 1a, 1b)

18. Process according to one of the preceding claims, the identifying agent (11) being added by means of a capillary (10) of a pen or of a pipette to the application surface (5, 5a, 5b) formed on the carrier layer (1, 1a, 1b).

19. Counterfeit-proof marking having a carrier layer (1, 1a, 1b) having a communicating pore space and a probe contained therein formed from a first biomolecule,
characterized in that
the carrier layer (1, 1a, 1b) has a first marking surface (6) containing the probe and a second reference surface (7) not containing the probe.

20. Counterfeit-proof marking according to claim 19, the carrier layer (1, 1a, 1b) being prepared from a light-transparent or a reflecting material.

21. Counterfeit-proof marking according to one of claims 19 or 20, the carrier layer (1, 1a, 1b) being prepared from one of the following materials: cellulose, nitrocellulose, nylon, polyacrylamide gel, porous SiO₂, nonwoven glass fiber material.

22. Counterfeit-proof marking according to one of claims 19 to 21, the marking being formed from a mixture of different biomolecules containing the probe.

23. Counterfeit-proof marking according to one of claims 19 to 22, the probe being formed from one of the following biopolymers: synthetic single-stranded nucleic acids or their natural and/or synthetic analogs, antigens, proteins, such as antibodies, antibody fragments, derivatives of antibodies or antibody fragments, nucleic acid-binding proteins, receptors, ligands.

24. Counterfeit-proof marking according to one of claims 19 to 23, the probe being applied to the carrier layer (1, 1a, 1b) in a specified geometric arrangement.

25. Counterfeit-proof marking according to one of claims 19 to 24, the probe being applied to the carrier layer (1, 1a, 1b) by means of a printing process, preferably by means of an inkjet printing head.

26. Counterfeit-proof marking according to one of claims 19 to 25, the carrier layer (1, 1a, 1b) having a first application surface (5a), which is connected to the marking surface (6) or to a plurality of marking surfaces via a first route (8) or first routes.

27. Counterfeit-proof marking according to one of claims 19 to 26, the first application surface (5a) being connected to the reference surface (7) or to a plurality of reference surfaces via a second route (9) or second routes.

28. Counterfeit-proof marking according to one of claims 19 to 27, a second and/or further application surfaces (5, 5a, 5b) being provided, which is/are connected to one or more marking surfaces (6) and/or reference surfaces (7).

29. Counterfeit-proof marking according to one of claims 19 to 28, the carrier layer (1, 1a, 1b) being covered at least sectionally with a protective layer (3).

30. Counterfeit-proof marking according to one of claims 19 to 29, the protective layer (3) being designed to be transparent.

31. Counterfeit-proof marking according to one of claims 19 to 30, the carrier layer (1, 1a, 1b) being fixed to the article to be marked by means of an adhesive or a lamination.

32. Counterfeit-proof marking according to one of claims 19 to 31, the carrier layer (1, 1a, 1b) being provided on its fixing-sided surface with an adhesive film preferably an adhesive film having a peelable protective film.

33. Kit having a counterfeit-proof marking according to one of claims 19 to 32 and an identifying agent (11) containing second biomolecules corresponding to the probe.

34. Kit according to claim 33, the probe being formed from one of the following biopolymers: synthetic single-stranded nucleic acids or their natural and/or synthetic analogs, antigens, proteins, such as antibodies, antibody fragments, derivatives of antibodies or antibody fragments, nucleic acid-binding proteins, receptors, ligands.

35. Kit according to claim 34 or 35, the identifying agent being a molecular beacon formed at least sectionally complementarily to the first biopolymer.

36. Kit according to one of claims 33 to 35, the identifying agent (11) being contained in a capillary (10), a pen or a pipette.

37. Kit according to one of claims 33 to 36, a dye being admixed to the identifying agent (11).
